(19) United States
(12) Patent Application Publication
(10) Pub. No.: US 2014/0161059 A1
(43) Pub. Date: Jun. 12, 2014

(54) METHOD FOR TRANSMITTING AND RECEIVING DATA IN COMMUNICATION SYSTEM USING MULTIPLE ANTENNAS AND APPARATUS THEREFOR

(71) Applicant: Electronics & Telecommunications Research Institute, Daejeon (KR)

(72) Inventors: Moon Sik LEE, Daejeon (KR); Jun Hwan LEE, Seoul (KR); Young Seog SONG, Daejeon (KR); Seung Eun HONG, Daejeon (KR); Eun Young CHOI, Daejeon (KR)

(73) Assignee: Electronics & Telecommunications Research Institute, Daejeon (KR)

(21) Appl. No.: 14/097,449

(22) Filed: Dec. 5, 2013

(30) Foreign Application Priority Data
Dec. 5, 2012 (KR) 10-2012-0140409
Dec. 4, 2013 (KR) 10-2013-0149677

(51) Int. Cl. H04W 72/08; H04B 7/06

(52) U.S. Cl. CPC H04W 72/082; H04B 7/061
USPC 370/329

(57) ABSTRACT

There are provided a method for transmitting and receiving data in communication system using multiple antennas and an apparatus for the same. The method of transmitting data in a base station may comprise receiving information on at least one beam causing interferences from a served terminal and transmitting control information to be used for cancelling interferences caused by the at least one beam to the served terminal. Thus, according to the present invention, interference may be controlled effectively in a communication system using multiple antennas.

### CROSS-REFERENCE TO RELATED APPLICATIONS

This application claims priority to Korean Patent Applications No. 10-2012-0140409 filed on Dec. 5, 2012 and No. 10-2013-0149677 filed on Dec. 4, 2013 in the Korean Intellectual Property Office (KIPO), the entire contents of which are hereby incorporated by reference.

### BACKGROUND

1. Field

Example embodiments of the present invention relate in general to a technology of transmitting and receiving data in cellular communication, and more specifically, to a method for transmitting and receiving data which controls interference generated during data transmission through multiple antennas and an apparatus for the same.

2. Description of Related Art

Recently, usage of mobile terminals such as smartphone and tablet is increasing rapidly, and so amount of data traffic used for the mobile terminals is also increasing rapidly. In addition, type of data traffic is being transitioned from voice and text data to high quality video data so that amount of data traffic through mobile terminals is increasing more rapidly.

Since frequency resources are limited resources although the data traffic through mobile terminals is increasing, it is difficult to meet the increasing amount of data traffic by using only current frequency resources. Therefore, a super high frequency (SHF) band and an extremely high frequency (EHF) band, which have wide band widths, are required to be used for performing cellular communication in order to resolve the above mentioned problem.

The SHF has a range from 3 GHz to 30 GHz, and has been called as micro wave. On the other hand, the EHF has a range from 30 GHz to 300 GHz, and has been called as millimeter wave.

In the case that cellular communication performed through the SHF or EHF band, radio capacity may be increased revolutionarily, since wide bandwidth is obtained and usage of spatial resource becomes possible as well as time, frequency, and code resources by shaping beam based on wave characteristic of directivity.

Meanwhile, a system using multiple antennas (for example, multiple input multiple output; MIMO) transmits data by using independent channel for each antenna so as to enhance transmission reliability and transmission throughput without additional frequency or transmission power. That is, the system using multiple antennas may increase system gain through diversity gain, and increase transmission throughput through multiplexing gain. Also, the system using multiple antennas may be extended to a multi-user multi antenna system supporting multiple users simultaneously.

The multi-user multi antenna system may perform communications with a plurality of users at the same time by using spatial resources obtained through multiple antennas, and increase efficiency of frequency use thereby. However, there is a problem that interference between users may degrade system capacity in the multi-user multi antenna system.

### SUMMARY

Accordingly, example embodiments of the present invention are provided to substantially obviate one or more problems due to limitations and disadvantages of the related art.

An example embodiment of the present invention provides a method of transmitting data, which can cancel interferences between beams.

Another example embodiment of the present invention provides a method of receiving data, which can cancel interferences between beams.

In an aspect of an example embodiment, a method of transmitting data in a base station performing communication by using multiple antennas may comprise receiving information on at least one beam causing interferences from a served terminal, and transmitting control information to be used for cancelling interferences caused by the at least one beam to the served terminal.

The method may further comprise transmitting data to terminals belonging to the base station by using the same radio resource and the same modulation and coding scheme.

The method may further comprise transmitting data to terminals belonging to the base station by using the same terminal identifier.

Here, the information on at least one beam may include a beam identifier of the at least one beam.

Here, the control information may include at least one of a beam identifier of the at least one beam causing interference, a terminal identifier, a resource allocation information, a modulation and coding scheme (MCS) information, and a number of radio slot.

Here, the base station may perform the communication in a multi-user multiple input multiple output (MU-MIMO) manner.

Here, each of the multiple antennas may be a horn-type antenna.

Here, the base station may perform the communication in a super high frequency (SHF) band or an extremely high frequency (EHF) band.

In another aspect of an example embodiment, a method of transmitting data in a base station performing communication by using multiple antennas may comprise estimating an uplink channel of adjacent beam based on signals received from terminals, performing precoding on downlink data based on the channel estimation, and transmitting the precoded downlink data to respective terminal.

Here, the base station may perform the communication in a multi-user multiple input multiple output (MU-MIMO) manner.

Here, the base station may perform the communication in a super high frequency (SHF) band or an extremely high frequency (EHF) band.

Here, each of the multiple antennas may be a horn-type antenna.

In another example embodiment, a method of receiving data by a terminal in a communication system using multiple antennas may comprise obtaining information on at least one adjacent beam causing interferences based on strengths of signals received from a base station, transmitting the information on at least one adjacent beam to the base station, receiving control information used for cancelling interferences caused by the at least one adjacent beam from the base station, and cancelling the interferences caused by the at least one adjacent beam by using the control information.

Here, when a strength of a received signal is equal to or above a predefined threshold, a beam corresponding to the received signal is determined as a beam causing interference in the obtaining information.

Here, the cancelling the interference may comprise aligning the interferences caused by the at least one adjacent beam in a predefined space and cancelling the interferences aligned in the predefined space.

Here, the information on at least one adjacent beam may include a beam identifier of the at least one adjacent beam.

Here, the control information may include at least one of a beam identifier of the at least one beam causing interference, a terminal identifier, a resource allocation information, a modulation and coding scheme (MCS) information, and a number of radio slot.

Here, the base station may perform the communication in a multi-user multiple input multiple output (MU-MIMO) manner.

Here, each of the multiple antennas may be a horn-type antenna.

Here, the terminal may perform the communication in a super high frequency (SHF) band or an extremely high frequency (EHF) band.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram to illustrate a downlink transmission in a communication system using multiple antennas;

FIG. 2 is a message sequence chart to explain a method of transmitting and receiving data according to an example embodiment of the present invention;

FIG. 3 is a conceptual diagram to illustrate an uplink link transmission in a communication system using multiple antennas;

FIG. 4 is a conceptual diagram to show an example of downlink cooperative transmission in a communication system using multiple antennas; and

FIG. 5 is a message sequence chart to show a method of transmitting and receiving data according to another example of the present invention.

### DETAILED DESCRIPTION

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “terminal” used in this specification may be referred to as User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words. The terminal may be a cellular phone, a smart phone having a wireless communication function, a Personal Digital Assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

Also, the term “base station” used in this specification means a fixed point that communicates with terminals, and may be referred to as another word, such as Node-B, eNode-B, a base transceiver system (BTS), an access point, etc. Also, the term “base station” means a controlling apparatus which controls at least one cell. In a real wireless communication system, a base station may be connected to and controls a plurality of cells physically, in this case, the base station may be regarded to comprise a plurality of logical base stations. That is, parameters configured to each cell are assigned by the corresponding base station.

Also, the term “network” used in this specification may include a mobile internet such as a Wireless Fidelity (WIFI), a Wireless Broadband Internet (WiBro), and a World Interoperability for Microwave Access (WiMax). Also, it may include 2G cellular network such as a Global System for Mobile communication (GSM) and a Code Division Multiple Access (CDMA), 3G cellular network such as a Wideband Code Division Multiple Access (WCDMA) and a CDMA2000. Also, it may include 3.5G cellular network such as a High Speed Downlink Packet Access (HSDPA) and a High Speed Uplink Packet Access (HSUPA). Also, it may include 4G or beyond 4G cellular network such as a Long Term Evolution (LTE) and a LTE-Advanced.

Hereinafter, embodiments of the present invention will be described in detail with reference to the appended drawings. In the following description, for easy understanding, like numbers refer to like elements throughout the description of the figures, and the same elements will not be described further.

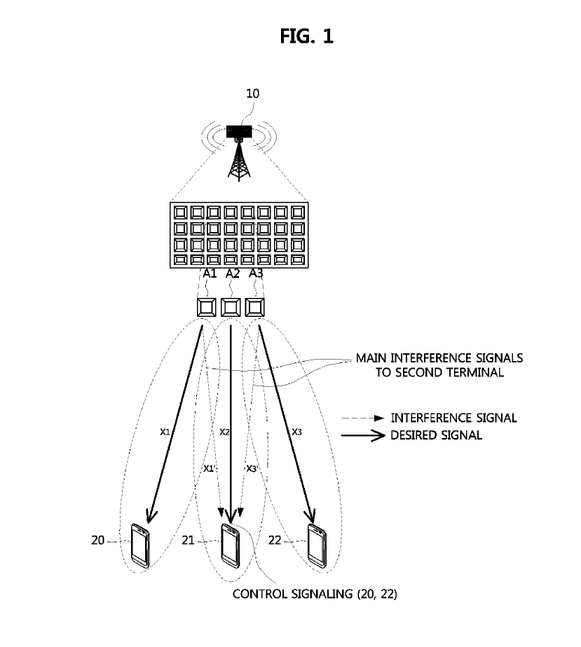

FIG. 1 is a conceptual diagram to illustrate a downlink transmission in a communication system using multiple antennas.

Referring to FIG. 1, a base station 10 may transmit downlink data to terminals 20, 21, and 22 in a multi-user multiple input multiple output (MU-MIMO) manner. The base station 10 may comprise a plurality of antennas, each of which may be a horn-type antenna. For example, the base station 10 may comprise 4×8 antennas. Also, the base station 10 may have an antenna configuration capable of adaptive beamforming or an antenna configuration capable of switched beamforming.

The base station 10 may transmit downlink data to a terminal by using a single antenna. For example, the base station 10 may use a first antenna A1 to transmit downlink data X1 to a first terminal 20, use a second antenna A2 to transmit downlink data X2 to a second terminal 21, and use a third antenna A3 to transmit downlink data X3 to a third terminal 22.

The transmissions between the base station 10 and the terminals 20, 21, and 22 may be performed by using a super high frequency band (SHF) or an extremely high frequency (EHF) band. The SHF has a range from 3 GHz to 30 GHz, and the EHF has a range from 30 GHz to 300 GHz. According to high directivity characteristic of the SHF and EHF bands, interferences between adjacent antennas may be minimized when MIMO transmissions are performed in the SHF or EHF band.

Accordingly, interference signal X2′ caused by a beam of the second antenna may be minimized in the first terminal 20, interference signal X1′ caused by a beam of the first antenna A1 and interference signal X3′ caused by a beam of the third antenna A3 may be minimized in the second terminal 21, and the interference signal X2′ caused by a beam of the second antenna A2 may be minimized in the third terminal 22.

However, in real environment, even though interferences caused by adjacent beams are minimized by beam shaping, the interferences between adjacent beams cannot be ignored and further cancellation techniques of interference between adjacent beams should be performed in order to enhance receiving performance.

That is, although a signal which the second terminal 21 desires to receive is X2, a signal received by the second terminal 21 may be X2+X1′+X3′ according to interferences caused by adjacent beams. Thus, in order to enhance receiving performance, the interference signals X1′ and X3′ should be cancelled.

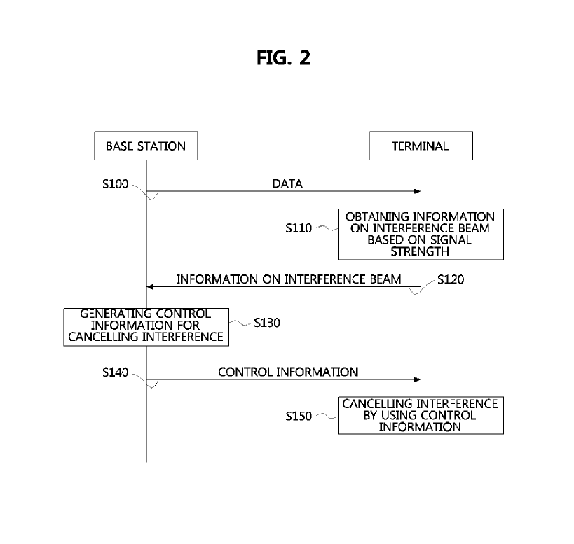

FIG. 2 is a message sequence chart to explain a method of transmitting and receiving data according to an example embodiment of the present invention.

Referring to FIG. 2, a base station may transmit data to terminals belonging to itself in a MU-MIMO manner at S100. Here, the base station may mean the base station depicted in FIG. 1. That is, the base station may comprise a plurality of antennas, and each of which is a horn-type antenna. The base station may have an antenna configuration capable of adaptive beamforming or an antenna configuration capable of switched beamforming. Also, the base station may use a SHF band or an EHF band for transmitting data to terminal.

A terminal may obtain information on at least one beam causing interferences to itself based on strength of signal received from the base station at S110. That is, the terminal may determine at least one beam having signal strength equal to or above a predefined threshold as a beam causing interference, and obtain information on the at least one beam having signal strength equal to or above a predefined threshold. Here, the information may include a beam identifier (for example, a cell identifier) of the at least one beam causing interference.

Since a terminal may know a sequence of identifiers having the highest signal strength (that is, degree of interference), the terminal may identify identifier of beam causing interference even though the terminal did not receive the beam identifier from the base station explicitly. For example, the terminal may determine that a beam adjacent to a beam which it desires to receive causes the highest interference, and so the terminal may identify an identifier of the adjacent beam by using the identifier of itself.

The may transmit the information on at least one beam causing interference to the base station at S120. At this time, the terminal may transmit the information on at least one beam causing interference to the base station by using a SHF or EHF band.

When the information on at least one beam causing interference is received from the terminal, the base station may generate control information to be used for cancelling interference caused by the at least one beam at S130. The control information may include a terminal identifier (for example, a radio network temporary identifier (RNTI)) corresponding to a terminal receiving the at least one beam causing the interference, a beam identifier corresponding to the at least one beam causing interference, a resource allocation information, a modulation and coding scheme (MCS) information, the number of used radio slot, etc. All the information described above may be included in the control information, or some of the information described above may be included in the control information according to necessity. Also, additional information as well as the information described above may be included in the control information.

The base station may transmit the control information to a terminal through downlink signaling at S140. Meanwhile, the base station may inform the terminal of the control information by using an implicit method as well as an explicit method such as the signaling.

As an example of the implicit method, the base station may transmit signals of a terminal and terminals causing interference to the terminal by using the same radio resource and the same MCS. In this case, the terminal receiving the signals may know radio resources and MCSs used by the adjacent beams, and so the terminal can cancel interference by using the radio resources and MCSs.

As another example of the implicit method, the base station may temporarily configure terminal identifiers of the terminals belonging to the base station as identical, and so the terminal may be informed of terminal identifier without additional signaling.

When the control information is received from the base station, the terminal may cancel interferences caused by the at least one beam based on the received control information at S150. For example, the terminal may align interference signals of the at least one beam in a predefined space by using the received control information. At this time, the terminal may use a technique of interference alignment so as to align the interference signals in a predefined space. Then, the terminal may cancel interference signals aligned in the predefined space, and known techniques such as zero-forcing may be used to cancel the interference signals.

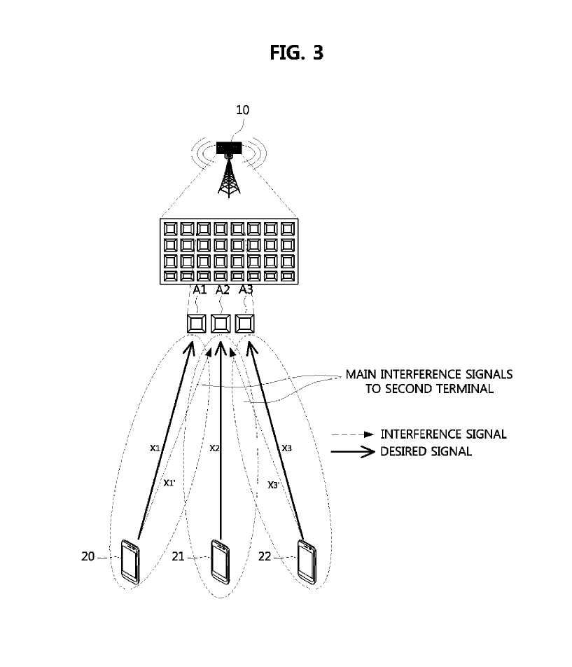

FIG. 3 is a conceptual diagram to illustrate an uplink link transmission in a communication system using multiple antennas.

Referring to FIG. 3, a base station 10 may receive uplink data from terminals 20, 21, and 22 in a multi-user multiple input multiple output (MU-MIMO) manner. The base station 10 may comprise a plurality of antennas, each of which may be a horn-type antenna. For example, the base station 10 may comprise 4×8 antennas. Also, the base station 10 may have an antenna configuration capable of adaptive beamforming or an antenna configuration capable of switched beamforming.

The base station 10 may receive uplink data from a terminal by using a single antenna. For example, the base station 10 may use a first antenna A1 to receive uplink data X1 from a first terminal 20, use a second antenna A2 to receive uplink data X2 from a second terminal 21, and use a third antenna A3 to receive uplink data X3 from a third terminal 22. The transmission between the base station 10 and the terminals 20, 21, and 22 may be performed by using a super high frequency band (SHF) or an extremely high frequency (EHF) band.

Meanwhile, the terminals 20, 21, and 22 transmit uplink reference signals using orthogonal codes which prevent the reference signals from interfering to each other. The base station 10 may cancel interferences on uplink data by using the reference signals having orthogonality.

The base station 10 may receive a signal X1+X2′ including a signal X1 which the base station desires to receive from the first terminal 20 through a first antenna A1 and a signal X2′ which is interference signal caused by the adjacent beam (that is, interference signal due to a signal X2 of the second terminal 21). The base station 10 may receive a signal X1′+X2+X3′ including a signal X2 which the base station desires to receive from the second terminal 21 through a second antenna A2 and signals X1′ and X3′ which are interference signals caused by the adjacent beams (that is, interference signals due to a signal X1 of the first terminal 20 and a signal X3 of the third terminal 22). The base station 10 may receive a signal X3+X2′ including a signal X3 which the base station desires to receive from the third terminal 22 through a third antenna A3 and a signal X2′ which is interference signal caused by the adjacent beam (that is, interference signal due to a signal X2 of the second terminal 21).

In this case, since the base station 10 knows control information of the terminals 20, 21, and 22 belonging to itself, the base station 10 may cancel interference by using the control information. The control information may include a terminal identifier (for example, a radio network temporary identifier (RNTI)) corresponding to a terminal transmitting the at least one beam causing the interference, a beam identifier corresponding to the at least one beam causing interference, a resource allocation information, a modulation and coding scheme (MCS) information, the number of used radio slot, etc.

For example, the base station 10 may use control information of the second terminal 21 to cancel interference signal X2′ due to a beam for the second terminal 21 included in signal X1+X2′ received through the first antenna A1. That is, the base station 10 may align the interference signal X2′ in a predefined space by using the control information of the second terminal 21, and cancel the interference signal X2′ aligned in the predefined space by using a zero-forcing technique.

The base station 10 may use control information of the first and third terminals 20 and 22 to cancel interference signal X1′ and X3′ due to beams for the first and third terminals 20 and 22 included in signal X1′+X2+X3′ received through the second antenna A2. That is, the base station 10 may align the interference signals X1′ and X3′ in a predefined space by using the control information of the first and third terminals 20 and 22, and cancel the interference signals X1′ and X3′ aligned in the predefined space by using a zero-forcing technique.

The base station 10 may use control information of the second terminal 21 to cancel interference signal X2′ due to a beam for the second terminal 21 included in signal X3+X2′ received through the third antenna A3. That is, the base station 10 may align the interference signal X2′ in a predefined space by using the control information of the second terminal 21, and cancel the interference signal X2′ aligned in the predefined space by using a zero-forcing technique.

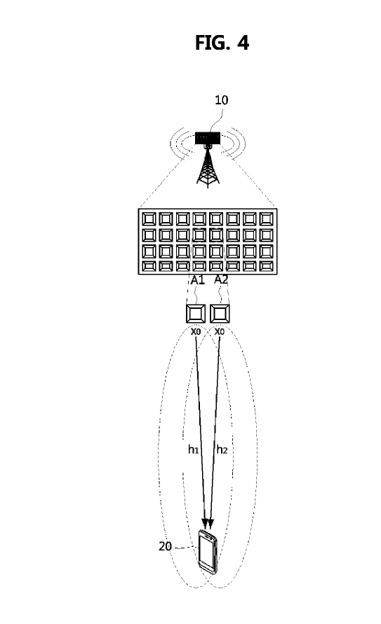

FIG. 4 is a conceptual diagram to show an example of downlink cooperative transmission in a communication system using multiple antennas.

Referring to FIG. 4, a base station 10 may transmit downlink data to a first terminal 20 in a multiple input multiple output (MIMO) manner. The base station 10 may comprise a plurality of antennas, each of which may be a horn-type antenna. For example, the base station 10 may comprise 4×8 antennas. Also, the base station 10 may have an antenna configuration capable of adaptive beamforming or an antenna configuration capable of switched beamforming. The transmission between the base station 10 and the terminal 20 may be performed by using a super high frequency band (SHF) or an extremely high frequency (EHF) band.

When a terminal is located at a boundary region of a cell served by an antenna and a cell served by another antenna adjacent to the antenna, the base station 10 may transmit downlink data to the corresponding terminal by performing cooperation between beams.

For example, when the first terminal 20 is located at a boundary region of a cell served by a first antenna A1 and a cell served by a second antenna A2, the base station 10 may transmit downlink data to the first terminal 20 by using the first antenna A1 and the second antenna A2. Here, although a case that downlink data is transmitted by using cooperation of two antennas (two beams), more than three beams may be cooperated to transmit downlink data.

In a case of cooperative transmission with four beams, as compared with a time-division multiplexing (TDM) or a frequency-division multiplexing (FDM), 6 dB signal to noise ratio (SNR) gain can be achieved as a maximum gain in a fading channel, and 12 dB SNR gain also can be achieved as a maximum gain in an addictive white gaussian noise (AWGN) channel.

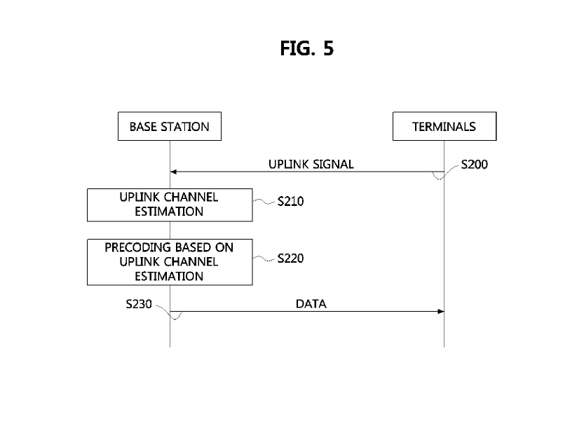

FIG. 5 is a message sequence chart to show a method of transmitting and receiving data according to another example of the present invention.

Referring to FIG. 5, a base station may transmit data to or receive data from terminals belonging to itself in a multi-user multiple input multiple output (MU-MIMO) manner. Here, the base station may mean the base station depicted in FIG. 1. That is, the base station may comprise a plurality of antennas, each of which may be a horn-type antenna. The base station may have an antenna configuration capable of adaptive beamforming or an antenna configuration capable of switched beamforming. The base station may transmit data to the terminals in a SHF band or an EHF band.

The base station may receive uplink signal from terminals belonging to itself at 5200. At this time, the base station may receive uplink signal from the terminals simultaneously through respective antenna, or receive uplink signal from the terminals sequentially according to scheduling. Here, the uplink signal may include reference signal to be used for estimation of uplink channel.

The base station may estimate uplink channel corresponding to each terminal based on uplink signal received from each terminal at S210. At this time, the base station may calculate an uplink channel estimation value ĥ of adjacent beams through cooperation of multiple beams managed by itself.

The base station may perform precoding on downlink data based on the uplink channel estimation value ĥ at S220. The base station may use an uplink channel estimation value on a first beam (that is, a beam corresponding to a first antenna) for transmitting downlink data through the first beam, use an uplink channel estimation value on a second beam (that is, a beam corresponding to a second antenna) for transmitting downlink data through the second beam, and use an uplink channel estimation value on a third beam (that is, a beam corresponding to a third antenna) for transmitting downlink data through the third beam.

The downlink signal precoded in the above mentioned manner may be represented as (ĥ*s/|ĥ|). Here, ĥ means an uplink channel estimation value, and S means original downlink signal.

The base station may transmit the precoded signal to terminals at S230. The terminals may receive signal transmitted, and signal y which is received by each terminal may be represented as

$$y = \frac{h {\hat{h}}^{*}}{\vert \hat{h} \vert} x + n = \vert h \vert x + n .$$

Here, x means original downlink signal, and n means noise.

When the above method is used, a channel on received signal may be changed from a fading channel to an AWGN channel, and receiving performance on the received signal may be enhanced.

Meanwhile, a plurality of cooperative beam sets for performing cooperation between beams belonging to the same set may exist, and a base station may reduce interferences between the cooperative beam sets by scheduling the cooperative beam sets.

According to the present invention, interference may be controlled effectively by cooperation between beams in a communication system using multiple antennas.

While the example embodiments of the present invention and their advantages have been described in detail, it should be understood that various changes, substitutions and alterations may be made herein without departing from the scope of the invention.

What is claimed is:

1. A method of transmitting data in a base station performing communication by using multiple antennas, comprising:
receiving information on at least one beam causing interferences from a served terminal; and
transmitting control information to be used for cancelling interferences caused by the at least one beam to the served terminal.

2. The method of claim 1, further comprising transmitting data to terminals belonging to the base station by using the same radio resource and the same modulation and coding scheme.

3. The method of claim 1, further comprising transmitting data to terminals belonging to the base station by using the same terminal identifier.

4. The method of claim 1, wherein the information on at least one beam includes a beam identifier of the at least one beam.

5. The method of claim 1, wherein the control information includes at least one of a beam identifier of the at least one beam causing interference, a terminal identifier, a resource allocation information, a modulation and coding scheme (MCS) information, and a number of radio slot.

6. The method of claim 1, wherein the base station performs the communication in a multi-user multiple input multiple output (MU-MIMO) manner.

7. The method of claim 1, wherein each of the multiple antennas is a horn-type antenna.

8. The method of claim 1, wherein the base station performs the communication in a super high frequency (SHF) band or an extremely high frequency (EHF) band.

9. A method of receiving data by a terminal in a communication system using multiple antennas, comprising:
obtaining information on at least one adjacent beam causing interferences based on strengths of signals received from a base station;
transmitting the information on at least one adjacent beam to the base station;
receiving control information used for cancelling interferences caused by the at least one adjacent beam from the base station; and
cancelling the interferences caused by the at least one adjacent beam by using the control information.

10. The method of claim 9, wherein when a strength of a received signal is above a predefined threshold, a beam corresponding to the received signal is determined as a beam causing interference in the obtaining information.

11. The method of claim 9, wherein the cancelling the interference comprises aligning the interferences caused by the at least one adjacent beam in a predefined space and cancelling the interferences included in the predefined space.

12. The method of claim 9, wherein the information on at least one adjacent beam includes a beam identifier of the at least one adjacent beam.

13. The method of claim 9, wherein the control information includes at least one of a beam identifier of the at least one beam causing interference, a terminal identifier, a resource allocation information, a modulation and coding scheme (MCS) information, and a number of radio slot.

14. The method of claim 9, wherein the base station performs the communication in a multi-user multiple input multiple output (MU-MIMO) manner.

15. The method of claim 9, wherein each of the multiple antennas is a horn-type antenna.

16. The method of claim 9, wherein the terminal performs the communication in a super high frequency (SHF) band or an extremely high frequency (EHF) band.

17. A method of transmitting data in a base station performing communication by using multiple antennas, comprising:
estimating an uplink channel of adjacent beam based on signals received from terminals;
performing precoding on downlink data based on the channel estimation; and
transmitting the precoded downlink data to respective terminal.

18. The method of claim 17, wherein the base station performs the communication in a multi-user multiple input multiple output (MU-MIMO) manner.

19. The method of claim 17, wherein the base station performs the communication in a super high frequency (SHF) band or an extremely high frequency (EHF) band.

20. The method of claim 17, wherein each of the multiple antennas is a horn-type antenna.
